(19) United States
(12) Patent Application Publication
(10) Pub. No.: US 2020/0135191 A1
(43) Pub. Date: Apr. 30, 2020

(54) Digital Voice Butler

(71) Applicant: BBY Solutions, Inc., Richfield, MN (US)

(72) Inventor: Farhad Nourbakhsh, Apple Valley, MN (US)

(73) Assignee: BBY Solutions, Inc., Richfield, MN (US)

(21) Appl. No.: 16/174,676

(22) Filed: Oct. 30, 2018

(51) Int. Cl. G10L 15/22; G10L 13/02; G10L 15/18

(52) U.S. Cl. CPC G10L 15/22; G10L 2015/223; G10L 15/1822; G10L 13/02

(57) ABSTRACT

A universal voice control system (aka: a Digital Voice Butler or DVB) is used to communicate with and control one or more voice activated smart devices (VASDs) with a single shared activation word. The DVB is embodied in a housing that contains a microphone, a speaker, a voice synthesizer, a list of understood spoken commands, a look up table having objects acted upon by the commands and ecosystem specific commands, and a processor in electronic communication with the microphone and speaker. A device such as a smart phone is in communication with the processor and provides a user interface for the DVB that allows specific VASDs and their associated functions to be linked to the DVB.

### FIELD OF THE INVENTION

The present disclosure relates to voice controlled electronic devices and systems such as “smart speakers” and the extended Internet of things (IoT) environment in which they are used. More specifically, embodiments of the present disclosure are directed to a device, system and method of use that provide a user with a single system solution for controlling one or more voice activated systems and their associated appliances, services, and/or functions.

### SUMMARY

Various voice activated systems exist, and each of these systems employ their own particular types of virtual assistants, trigger words, language interfaces, user controls, etc. In a given environment one might encounter an Amazon Echo smart speaker and its Alexa virtual assistant, an iPhone with its Siri virtual assistant, a PC computer running a Microsoft operating system featuring the Cortana virtual assistant, etc. All of these “smart” systems and their voice activated virtual assistants may be connected to a variety of IoT devices and services in order to allow a user to control such devices by a variety of trigger phrases that are unique to each smart system.

In such a mixed smart device environment (an environment that is becoming increasingly more common as voice activated systems become more popular), a user must keep track of what devices are controlled by which virtual assistants/smart systems and what the appropriate trigger words or phrases must be used in order to properly interface with the device and linked virtual assistant in question.

The present disclosure provides a universal voice control device and system, referred to herein as a “digital voice butler” or DVB, which when properly configured, allows a user to use a single set of voice commands, unique to the DVB, to interface and thereby control any and all voice activated systems within a given environment of use.

In operation, the DVB system, employs a smart phone interface, linked via Bluetooth, Wi-Fi or via other communication mechanism to configure the DVB system, populate and update assignment tables, and edit activation and command phrases. The DVB system is then utilized to communicate audibly with any voice activated devices within an environment of use (a room or rooms, office, home, etc.). The DVB allows the user to control any connected voice activated smart device (and associated virtual assistant) without the need to use the specific format of the smart devices in question. The DVB will receive or “hear” (via a microphone) a voice command from the user, and then automatically translate the spoken command and audibly repeat it (via a speaker) in a format required by a particular virtual assistant or smart device.

For example, in a given environment an Amazon Alexa smart speaker is connected to a lamp via an IoT smart plug. The command “Alexa, turn on the lights” is required to be spoken aloud in order for the Alexa virtual assistant to activate the smart plug and turn on the lamp. In the same environment an Apple Homepod smart speaker is connected to the Apple iCloud where a user's music collection is stored, and a spoken command such as “Hey Siri, play music” is necessary for the Siri virtual assistant to access the iCloud and begin playing music. When the Homepod and Alexa smart speakers are properly connected to the DVB system, a user merely states the command associated with the DVB, such as “turn on the lights and play music” or even “I'm home,” and the DVB will automatically recite the properly formatted commands of “Alexa, turn on the lights” and “Hey Siri, play music” to alleviate from the user the need remember which smart speaker controls which device or system.

In some embodiments, the DVB includes an assigned activation word or phrase such as, for example, “Alice” or some other unique DVB activation word that it may be desirable for the DVB to first receive before acting on a subsequent spoken command so as to prevent inadvertent use of the DVB system.

With the DVB as described herein any number of voice activated systems and their associated linked devices and/or functions can be controlled with a single type of command phrasing unique to the DVB.

### BRIEF DESCRIPTION OF THE DRAWINGS

FIG. 1 is a schematic view of an example PRIOR ART voice activated, smart device eco system.

FIG. 2 is a schematic view of the DVB device and its interface and manner of use with a known voice activated speaker system.

FIG. 3 is a schematic view of the DVB device and its interface and manner of use with a plurality of known voice activated speaker/virtual assistant systems.

FIG. 4 is a schematic view of the operational elements of the DVB in conjunction with the user interface.

FIG. 5 is a diagrammatic view of the method of operation of the DVB shown in FIG. 4.

FIG. 6 is an exemplary view illustrating an example user interface for the configuration of the DVB system shown in FIG. 4.

### DETAILED DESCRIPTION

As mentioned above, embodiments of the present disclosure are directed to a device and system that provides a “universal” interface for the control of voice activated smart device and their associated virtual assistants.

As a point of definition, a voice activated smart device (VASD), is not limited to devices such as smart speakers, but should be understood to include any electronic device having a voice activated virtual assistant capable of controlling a connected device or service. Examples of such VASDs include, but are not limited to Amazon's Echo smart speaker with the Alexa virtual assistant, Google's Google Home smart speaker and associated virtual assistant, a personal computer running Microsoft Windows' with the Cortana virtual assistant, various Apple products such as the Homepod and iPhone with the Siri virtual assistant, etc.

Presently, the various commercially available VASDs have the common capability of being linked to other devices or services around a user's home, which may then also be controlled by voice command given to the controlling VASD by a user.

As VASDs have become more ubiquitous, and given that some VASDs are sometimes limited to particular areas of use (e.g. Microsoft Windows' Cortana is typically used to access aspects of the Windows computing environment, such as calling up programs and using them by voice; where as a smart speaker such as the Apple Homepod may be connected to various appliances such as a smart plug or a smart home thermostat to allow the user to control the appliances by voice control), it is becoming more and more common to encounter environments where multiple VASDs are present and in control of a variety of different devices and systems. In such a multiple VASD environment, such as a home or office, a user must know the proper trigger phrases for each VASD and likewise be aware of the specific devices and systems that each VASD controls.

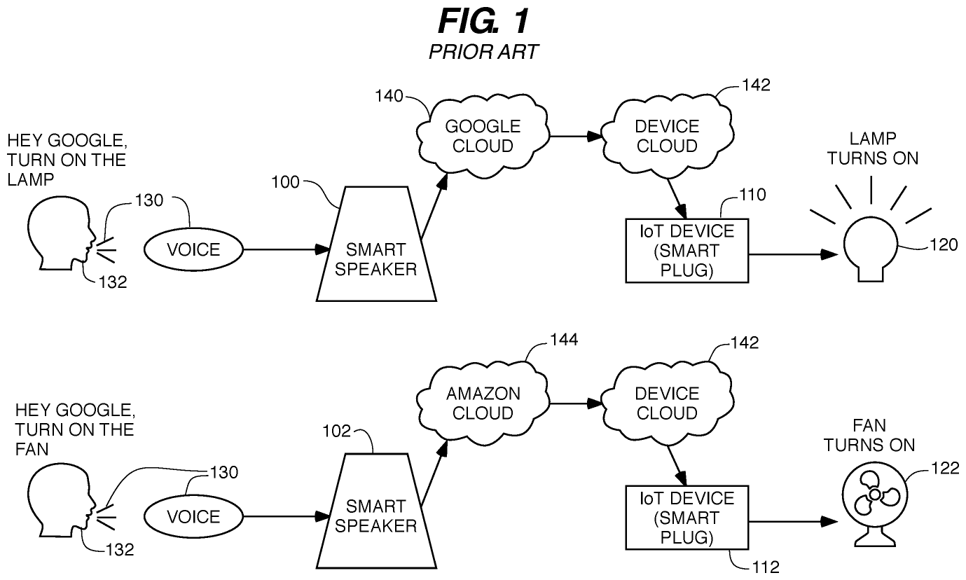

An example of an environment wherein multiple VASDs are present is illustrated in PRIOR ART FIG. 1 wherein an environment is depicted where a first VASD 100, such as a Google Home smart speaker is shown in operational communication with an IoT smart plug 110, which is operatively connected to a light fixture such as a lamp 120. A command 130 is spoken aloud by a user 132 in order to activate the control functionality of the VASD 100. The spoken command 130 must include an initial activation phrase in the proper format required by the VASD's operational ecosystem. In the example illustrated, a Google Home smart speaker would require the prefatory activation phrase of “Hey Google . . . ” in order for the VASD 100 to be activated, recognize the subsequent command of “ . . . turn on the light”, and then transmit a signal through the appropriate communication ecosystems (proprietary clouds) 140 and 142 of the VASD 100 and IoT smart plug 110 respectively; in order to activate the IoT smart plug 110 and finally turn on the light source of the lamp 120.

In this same environment of use, another VASD 102 is present. In this case, it is in the form of a Amazon Alexa smart speaker. The VASD 102 is in communication with a second IoT smart plug 112, which is operatively connected to an appliance such as a fan 122. In the case of the Alexa VASD 102, the user 132 must include with the command 130 a different prefatory activation phrase than the Google Home VASD 100 in order to activate the Alexa VASD 102. In this case, the prefatory command is the stated word “Alexa . . . ” followed by the command “ . . . turn on the fan”. Like other VASDs, the Alexa VASD 102 then transmits the appropriately formatted command through its communication ecosystem 144 and that of the IoT smart plug 112 (cloud 142) in order to turn on the fan 122.

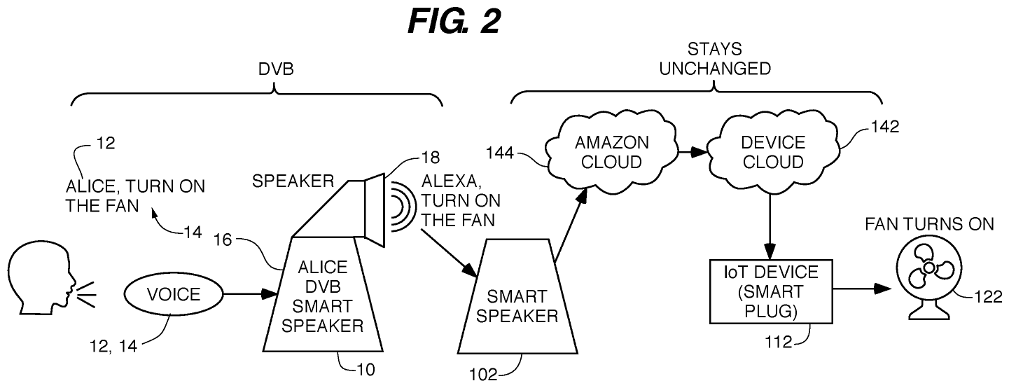

Thus, in the environment of use shown in PRIOR ART FIG. 1 it is necessary for the user 132 to be aware of what appliance is connected to which VASD and then properly state the appropriate prefatory activation phrase unique to each VASD, in order to execute even the simplest of tasks or commands. Embodiments of the present disclosure however, such as are illustrated in FIGS. 2-5, avoid this necessity by providing a single interface which will audibly communicate with any and all VASDs in an environment of use using a single user input communication schema or command structure.

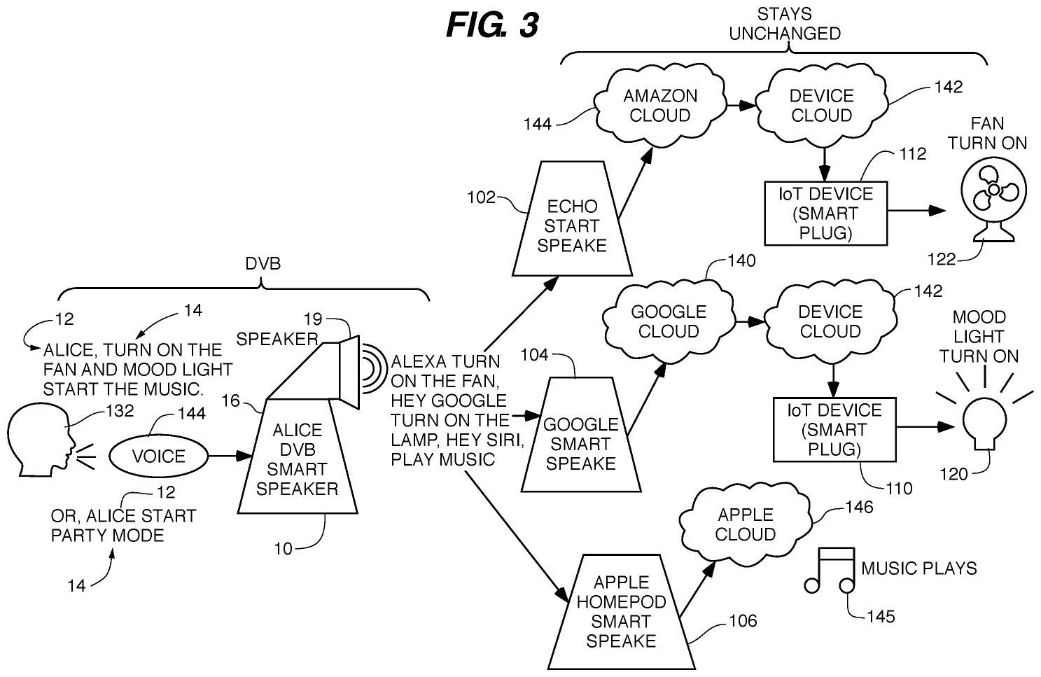

Illustrative examples of this interface are show in in FIGS. 2 and 3. In FIG. 2 a DVB smart speaker or VASD interface device 10 is shown in operative use with the Alexa VASD 102 and its associated components as were shown in PRIOR ART FIG. 1 and discussed above.

Once properly set up and connected (discussed in greater detail below), the DVB device 10 acts as the initial receiver of the user's spoken commands. When the user provides a prefatory activation phrase 12 and command 14 uniquely formatted to the DVB system (in this instance the prefatory activation phrase is exemplary illustrated as the spoken name “Alice”), the DVB device 10 receives this command via a built in microphone 16, processes the command and “translates” it into the format of the appropriate VASD 102 that the command is intended, and then re-states via a speaker 18 the appropriate VASD specific prefatory activation phrase and command aloud so that the VASD 102 can “hear” (i.e. receive the spoken activation phrase and command via its own microphone) the command and act upon it as if the user had spoken it directly.

In an environment of use where multiple VASDs and their various individual communication ecosystems are present, such as is illustrated in FIG. 3, the benefit of DVB device that allows a single communications schema to essentially replace (from the user's perspective) the individualized formats required by each VASD becomes apparent and appreciated. Even in environments of use with only a single VASD present such as, for example, a user's home having a specific VASD, and in a user's car with a different VASD, the use of a DVB system in each environment allows the user to use the single voice command schema of the DVB and thus avoid the need of remembering which VASD requires which command structure.

In the environment of use shown in FIG. 3 there are three different VASDs present. In this case, a first VASD 102 in the form of an Echo smart speaker with Alexa DVA; a second VASD 104, in the form of a Google smart speaker; and a third VASD 106 in the form of an Apple HomePod with the Siri DVA.

Each VASD is in operative control of a separate appliance or function that the user may wish to operate by voice control. In the case of the first VASD 102, it remains linked to a fan 122 via an IoT smart plug 112. In the case of the second VASD 104, it is linked to a lamp 120 also via an IoT smart plug 110. The third VASD 106, controls a user's collection of music 145 via a connection to a cloud based server or other offsite database 146.

All three VASDs have and require a unique audibly recited prefatory activation phrase or activating command to be received by the respective VASD in order to initiate their function and subsequently active or control the appliance or utility to which they are operatively connected. In the case of first VASD 102, “Alexa . . . ”; in the case of second VASD 104, “Hey Google . . . ”; and in the case of third VASD 106, “Hey Siri . . . ”. Without the use of the DVB device 10, the user is required to remember which VASD is connected to which appliance or utility, remember which VASD requires which prefatory activation phrase, and then properly and audibly voice the appropriate prefatory activation phrase and command each time control of any of the connected appliances or utilities is required. But with the DVB device 10, the DVB device 10 will allow a user to use a single style of prefatory activation phrase or custom word of the user's choice via the phone app, and associated commands, which upon receipt by the DVB device 10 will automatically be translated into the proper syntax required by an individual VASD linked thereto, so as to allow the user control over any and all VASDs without the need to articulate or even remember their specific prefatory activation phrases or commands.

As an example, in FIG. 3 the DVB device 10 is provided with the prefatory activation phrase of “Alice . . . ” When this is spoken aloud by the user 132, the DVB device 10 is activated to receive one or more commands. In the illustration shown the entire command statement of “Alice, turn on the fan and mood light, start the music” is received by the DVB device 10, parsed and translated by the DVB device 10, converted into separate and syntax appropriate commands necessary to interact with each of the VASD 102, 104 and 106 ecosystems, and then “spoken” (audibly transmitted) via speaker 18 as translated command(s) of “Alexa, turn on the fan; Hey Google, turn on the lamp; Hey Siri, play music.” As a result, each of the VASDs 102, 104 and 106, “hear” (receive via their own built in microphones) the properly spoken aloud command necessary for each to perform their programmed, voice activated functions despite the user 132 never having used the requisite respective ecosystem specific phrases.

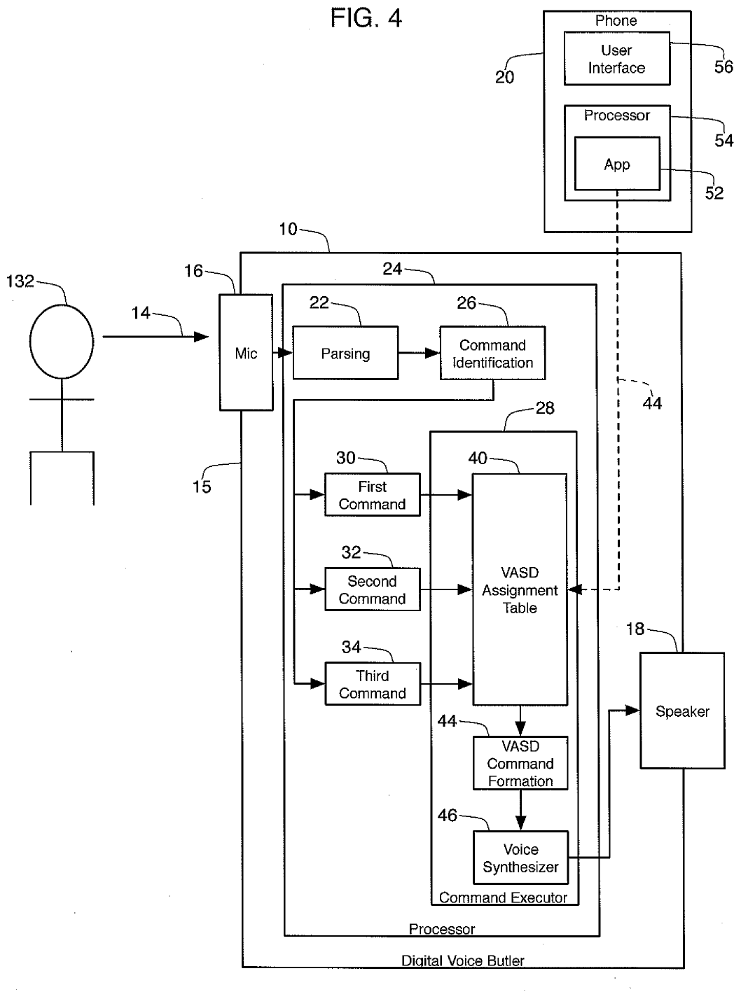

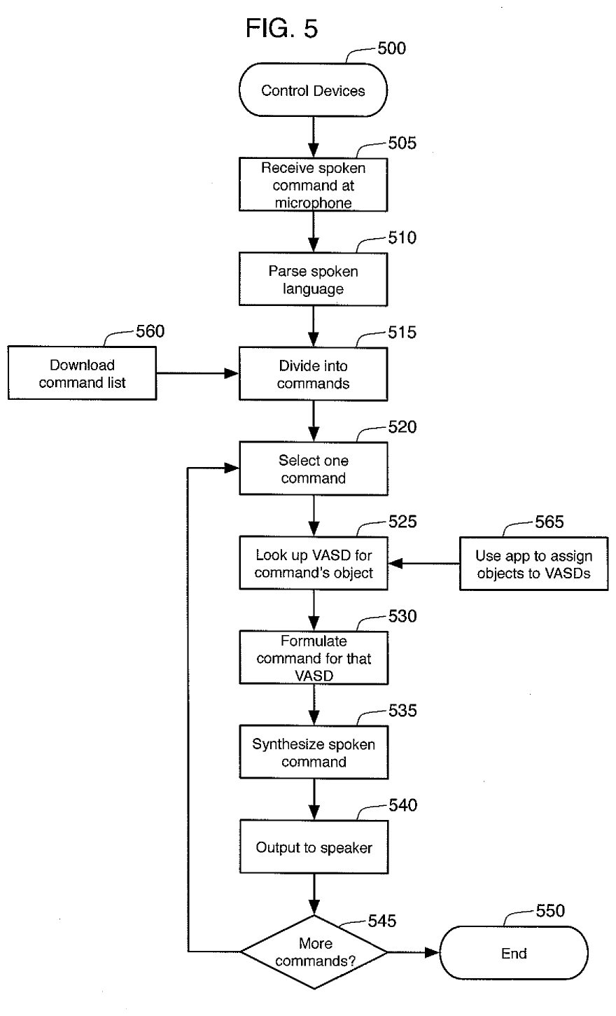

The operational characteristics which allows the DVB device 10 to provide this universal control or translation of existing VASDs to which it is operationally linked, is made possible by the components illustrated in FIG. 4. The method 500 for performed by the DVB device 10 is shown in FIG. 5, and will be discussed alongside the discussion of the components from FIG. 4. Here, component elements of the DVB device 10 are diagrammatically shown. As already discussed, the DVB device 10 includes a microphone 16 for receipt of the spoken commands 14 spoken aloud by a user 132. The microphone 16 and other components of the DVB device 10 are incorporated into a single housing 15.

The spoken command 14 is received by and formed into an electronic signal by the microphone 16 (step 505). This signal is then translated and parsed into its component phrases by a parsing function 22 of the processor programming. The processor is shown generally at element 24 and is contained within the housing 15. In one embodiment, the processor 24 is a general purpose processor, such as a reduced instruction set ARM processor produced according to a design provided by ARM Holdings PLC (Cambridge, England). The processor 24 operates according to programming instructions to perform tasks on digital data and signals. The various components of the programming controlling the processor 24 are shown schematically within the processor 24 on FIG. 4. In a physical implementation, the programming would likely be stored in non-volatile memory and then moved into volatile RAM when controlling the processor 24. While the non-volatile memory and RAM are not shown in FIG. 4, in the actual physical embodiment such memory devices would be located within the housing and would be in data communication with the processor 24.

The parsing component 22 of the processing instructions for the processor 24 receives the voice signals from the microphone 16. It is the job of the parsing component 22 to parse and interpret such signals as individual words and phrases, which is step 510 of method 500. This type of voice interpretation is well understood in the prior art, and is frequently performed on the same device that received the voice signals 14, as is the case with the embodiment shown in FIG. 4. In other embodiments, the voice signal received from the microphone 16 is transmitted to a remote, external server, where the voice is parsed into separate words and phrases and then returned to the local device for action. Although the embodiment in FIG. 4 shows the parsing function 22 being performed locally, it is possible to implement the DVB device 10 using the voice interpretation services of a remote server.

The parsed words and phrases identified by the parsing functionality 22 are then submitted to the command identification function 26, where the parsed instructions from user 132 are interpreted and converted into separate, generic commands 30, 32, 34. For instance, the verbal command “Alice, turn on the fan and mood light, start the music” 14 would be received by the microphone 16 and passed to the parsing component 22. The command identification component 26 analyzes the text presented by the parsing component 22, and determines that the verbal command includes three different commands instructions, namely turn-on-fan 30, turn-on-mood-light 32, and play-music 34. This is step 515. The command identification component 26 does not need to refer to these commands 30, 32, 34 using text-based syntax, but rather the commands 30, 32, 34 will generally constituted digital identifiers that uniquely identify the commands involved. The commands 30, 32, 34 frequently take the form of verb-object pairs.

The verb portion of a verb-object pair specifies a specific action to be performed, and can take the form of any of the specific actions that are understood by the VASD in an environment. Example actions might be to “turn on,” “turn off,” “set volume,” etc. The command identification component 26 converts the text language received from the parsing component 22 into one or more of these commands using a list of known actions. This list of actions can be considered to be a superset of all commands that are known by any of the VASDs that may exist in the home of a user 132. The commands understood by the command identification component 26 can be updated from time-to-time (step 560). This update can occur by having the DVB device 10 periodically contact a server (not shown) that maintains a list of these commands and simply downloads an update from that server. Alternatively, an app 52 operating on a mobile device 20 can contact the server and download the new commands to the DVB device 10. This app 52 is described in more detail below in connection with updating assignment table 40.

The object portion can be thought of as household objects that might be controlled by a VASD, such as a light or a television. In the preferred embodiment, the objects are specific to a particular household and have been predesignated by the user. In other words, rather than a command being “turn on the light,” the command will specify a specific light in the user's household—“turn on the kitchen light.” Similarly, rather than simply referring to “the smart outlet,” the user might refer to the “living room fan”.

The various commands 30, 32, 34 identified by the command identification component 26 are then received by the command executor 28. The command executor 28 is responsible for receiving the separate commands 30, 32, 34, determining which VASD is capable of performing each command, and then outputting the commands to the appropriate VASD through the speaker 18. In order to assign a command to a particular VASD, it is necessary to consult the VASD assignment database 40 which assigns each potential object in a verb-object pair to the VASD that controls that object. For example, the object in the three commands 30, 32, and 34 shown in FIG. 3 are the fan, the lamp, and the music, respectively. The VASD assignment table 40 keeps track of the fact that the fan is controlled by VASD 102, the lamp is controlled by VASD 104, and the music is controlled by VASD 106, as is shown in FIG. 3. The method 500 selects one of the commands produced by the command identification component 26 at step 520, and then looks up the object of that command in the VASD assignment table 40 to identify the VASD for that command at step 525. The VASD command formation component 44 then takes the command 30, 32, or 34 and formats it for the selected VASD selected (step 530). Once a specific command input is matched to its proper VASD ecosystem by the look up table 40 and formatted, a text to speech function (or voice synthesizer) 46 transforms the command output into an audio signal at step 535. The audio signal is then output to the speaker 18 at step 540 to transmit into the environment of use and thereby activate and control the VASD and associated object (such as an appliance or other system. At step 545, the method 500 determines if any more commands need to be transmitted (such as commands 32 and 34). If so, the next command is selected at step 520. If not, the system ends at step 550.

The VASD assignment look up table 40 is populated in part by user input via a wirelessly connection (represented by line 44) provided by a smart device (e.g. smart phone) 20 program application (i.e. an app) 52. The app 52 operates on the processor 54 of the smart device 20 and includes as part of its programming a listing of each VASD specific ecosystem that can receive commands as well as the objects that can controlled by each ecosystem. The app 52 will also include a listing of various devices and services that may exist in an environment of use. The lists of ecosystems and objects/devices are capable of being automatically updated via WI-FI, cellular or other type of connection with an internet connected database 58 (cloud). For instance, new versions of the app 52 can include a new VASD ecosystem, or an upgraded list of the types of objects that can be controlled by one of the VASD ecosystems. In addition, one or both lists may also be updated or populated manually by a user.

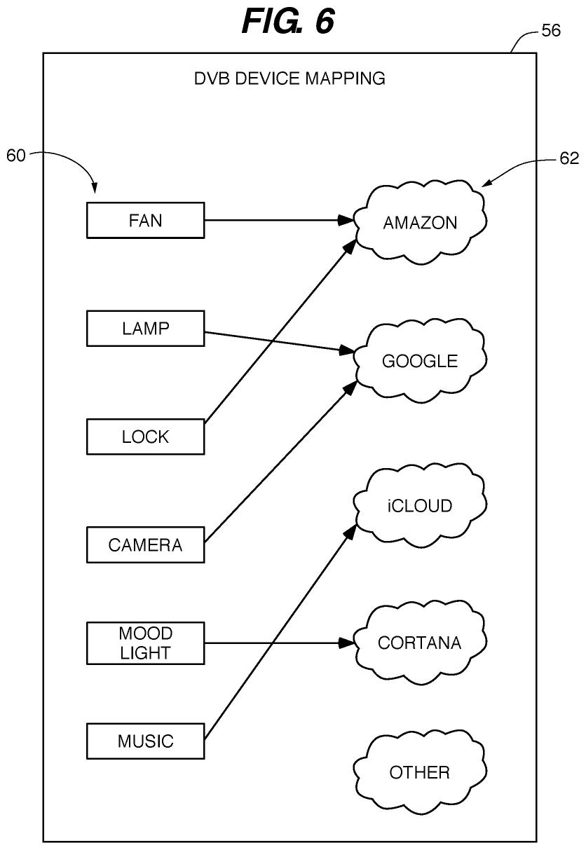

An example of the smart device 50 user interface 56 is shown in FIG. 6. In the example shown, a user (not shown) simply draws a line (with a finger or stylus) or taps a selection from among the objects/device list (blocks 60) and joins them to the appropriate ecosystem or VASD identifier of the ecosystems (clouds 62) available in the environment of use (which the app and DVB device 10 may detect automatically, by Bluetooth discovery, or other connection detection function). When the user adds a new smart device to home environment, the user may be required to manually add the device to left side of interface 56. Alternatively, the VASD might auto-recognize the device and allow quick configuration through its user interface. The VASD may then report all of the devices that it can control in a manner that can be understood by the app 52, allowing the app 52 to automatically add the device to the interface 56. Of course, some devices can be controlled by multiple VASDs, which is why the interface 56 requires the linking of each device to a particular VASD.

When the appropriate device 60 (see lamp 120 and fan 122 such as is shown in FIG. 3) is linked to the appropriate VASD and ecosystem 62 via the user interface 56, the app 52 will notify the DVB device 10 of the linkage and the DVB device 10 will update the VASD assignment table 40 (step 565 of method 500). The DVB device 10 is now capable of receiving the appropriately formatted or generic DVB commands from the user, then translating these commands into the specific VASD ecosystem specific commands, then audibly stating such translated commands in order to activate a specific VASD and its linked device(s) in the manner described above.

In this manner, the DVB device 10, in conjunction with the app 52 provide what is effectively a universal translator which allows a user to control any VASDs in the environment of use using a single spoken command format, regardless of the spoken command format that each VASD may individually require.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

1. A universal voice control system for communicating with and controlling multiple voice activated smart devices wherein each of the multiple voice activated smart devices has a unique initial activation phrase, the system comprising:
a) a housing, the housing containing
i) at least one microphone,
ii) a speaker,
iii) a voice synthesizer,
iv) a list of understood spoken commands,
v) a look up table comprising objects acted upon by the commands and ecosystem specific commands, and
vi) a processor, the processor being in electronic communication with the at least one microphone and speaker;
the processor having programming,
b) programming instructions for the processor, the programming instructions causing the processor to:
i) parse a verbal command received by the at least one microphone,
ii) identify a first command within the verbal command using the list of understood spoken commands, the first command being associated with a first object,
iii) use the look up table to identify a first specific voice activated smart device associated with the first object, the first specific voice activated smart device being one of the multiple voice activated smart devices,
iv) formulate the command for the first specific voice activated smart device,
v) use the voice synthesizer to output the initial activation phrase for the first specific voice activated smart device and the formulated command out the speaker.

2. The system of claim 1 further comprising a smart phone, the smart phone having a smart phone processor, the smart phone processor containing an app, the app having controls for linking the ecosystem each of the voice activated smart devices with at least one associated object.

3. A method for communicating and controlling voice activated smart devices comprising:
i) parsing a verbal command received by at least one microphone;
ii) identifying a first command within the verbal command using a list of understood spoken commands, wherein the first command is associated with a first object;
iii) identifying via a look up table a first specific voice activated smart device associated with the first object, and a unique initial activation phrase of the first specific voice activated smart device;
iv) formulating the unique initial activation phrase of the first specific voice activated smart device and the command associated with the first object; and
v) using a voice synthesizer to output the formulated unique initial activation phrase and command from a speaker.
